(19) United States
(12) Patent Application Publication
(10) Pub. No.: US 2005/0097496 A1
(43) Pub. Date: May 5, 2005

(54) High-speed and low-power logical unit

(76) Inventors: Hanpei Koike, Ibaraki (JP); Tadashi Nakagawa, Ibaraki (JP); Toshihiro Sekigawa, Ibaraki (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/951,759

(22) Filed: Sep. 29, 2004

(30) Foreign Application Priority Data
Sep. 30, 2003 (JP) 2003-341191

(51) Int. Cl. G06F 17/50; G06F 9/45

(52) U.S. Cl. 716/13; 716/6; 716/12

(57) ABSTRACT

It is an object of the present invention to provide a high-speed and low-power logical unit formed of a master slice integrated circuit, which offers advantages of reducing the cost and time required for designing masks, and in which a faster operation can be achieved while consuming low power by controlling the operation mode of each logical device forming the logical unit according to the operating state of the corresponding logical device. The high-speed and low-power logical unit comprises a plurality of logical devices including control-voltage input terminals for controlling operation modes, a voltage supply circuit for generating a plurality of different control voltages; and a wiring pattern for supplying a control voltage from the voltage supply circuit for controlling each of the logical devices to operate in an operation mode determined according to an operation of the corresponding transistor to the control-voltage input terminal of the corresponding logical device.

### TECHNICAL FIELD OF THE INVENTION

The present invention relates to a high-speed and low-power logical unit in which a faster operation can be achieved while consuming low power by controlling the operation mode of each logical device (such as a transistor) in an integrated circuit forming the logical unit according to the operating state of the corresponding logical device.

Description of Related Art

In a semiconductor integrated circuit, transistors and wiring patterns are disposed on a semiconductor substrate by using many masks to form an electronic circuit, for example, a logical unit. Nowadays, 20 to 30 masks are used for manufacturing one integrated circuit, and because of the progress of techniques for decreasing semiconductor devices to a very small size, the cost and time required for developing masks is increasing.

To solve this problem, a master slice integrated circuit (also referred to as a “gate array”) for reducing the cost and time required for developing masks is widely used, wherein the performance and arrangement of transistors integrated into an integrated circuit are uniformly standardized, and common masks for forming a logical device layer such as a transistor layer are used, so that only a few masks for forming wiring patterns for connecting the terminals of the transistors need to be individually designed by a user.

To form a logical unit achieving both high operating speed and low power consumption, the threshold of each transistor should be effectively adjusted. That is, when the threshold of a transistor is set to be higher, the driving current when the transistor is turned ON becomes decreased so as to hamper fast operation, but on the other hand, the leakage current when the transistor is turned OFF is suppressed to decrease the power consumption. In contrast, when the threshold of each transistor is set to be lower, the leakage current when the transistor is turned OFF is increased to raise the power consumption, but on the other hand, the driving current when the transistor is turned ON is increased to achieve fast operation.

In this manner, the operating speed and the power consumption of transistors have a tradeoff relationship. Accordingly, when the threshold of the transistors is fixed to one value, in order to increase the operating speed, all the transistors forming the logical unit must be operated at high speed, thereby unnecessarily increasing the power consumption. Conversely, to suppress the power consumption, the overall operating speed must be sacrificed. To overcome this drawback, it should be possible to form a logical unit achieving both fast circuit operation and low power consumption. However, attempts have not been made to form such a logical unit.

Japanese Laid Open Patent No. 11-39879 discloses a semiconductor apparatus, in which the substrate potential is selectively changed to adjust the thresholds of MOS field effect transistors, thereby controlling the power consumption of a static random access memory (SRAM) circuit used in memory circuitry. The SRAM circuit whose power consumption is controlled is set as a circuit-setting storage device for a logical circuit used in a field programmable gate array (FPGA). It is thus possible to provide a semiconductor apparatus achieving a fast writing speed and low power consumption.

In the semiconductor apparatus disclosed in the above Japanese Laid Open Patent, by changing the threshold voltages of MOS field effect transistors by selectively changing the substrate potential, the logical unit in the FPGA is set in the active state or in the standby state. According to the state of the logical unit, the overall power consumption can be suppressed while achieving fast operation when it is necessary. As in the invention in the Japanese Laid Open Patent, when the semiconductor apparatus has a logical unit in addition to an SRAM circuit, the threshold voltages can be individually controlled according to the states of the individual elements in the logical unit, for example, according to whether each element is in the active state or in the standby state. Thus, fast operation can be achieved when necessary while suppressing the overall power consumption.

### SUMMARY OF THE INVENTION

In a master slice integrated circuit, to share common masks in a semiconductor manufacturing process, the configuration of a logical device layer such as transistor layer is uniformly standardized. Accordingly, to form a logical unit, the threshold values of the individual logical devices such as transistors cannot be finely adjusted according to the operating states of the individual circuits. That is, in a conventional master slice integrated circuit, the operating speed (delay time between an input signal and an output signal) and the power consumption of all the logical devices (transistors) of the logical unit are determined as a whole by the device structure and the semiconductor manufacturing process. Thus, the operating speed and power consumption are fixed and uniform over the entire chip.

Generally, the operating speed and the power consumption of an electronic circuit have a tradeoff relationship. Accordingly, as stated above, to increase the operating speed, all the logical devices (such as transistors) forming the logical unit must be operated at high speed, thereby unnecessarily increasing the power consumption. Conversely, to suppress the power consumption, the overall operating speed must be sacrificed. Thus, when a logical unit is formed by using a master slice integrated circuit, in order to suppress the power consumption while the logical unit is not in the operating state, the overall logical unit must be in the standby state.

To overcome the above-described drawback, when manufacturing a master slice integrated circuit, for example, masks for forming and arranging several types of logical devices (such as transistors) having different threshold values by processing means are prepared, and such logical device are selectively used. In this method, however, the number of logical devices having different threshold values is unfavorably fixed by the design of the masks. Also, the required number of logical devices having specific threshold values is changed according to the specifications of a logical unit in the integrated circuit. This makes it difficult to effectively utilize all the logical devices in the integrated circuit. Additionally, since the positions of the logical devices having specific threshold values are fixed, the wiring patterns between these logical devices cannot be optimally disposed. This causes signal delay, thereby decreasing the operating speed of the logical unit.

To solve the above-described problems, it is an object of the present invention to provide a high-speed and low-power logical unit formed of a master slice integrated circuit, which offers advantages of reducing the cost and time required for designing masks, and in which a faster operation can be achieved while consuming low power by controlling the operation mode of each logical device forming the logical unit according to the operating state of the corresponding logical device.

In order to achieve the above-described object, according to the high-speed and low-power logical unit of the present invention, as a plurality of logical devices, which form a master slice integrated circuit, formed by a common mask(s), logical devices in which the threshold values can be controlled by an electrical method are used. Then, a physical value supply circuit for generating electrical signals for controlling the threshold values is disposed in the master slice integrated circuit. The output terminals of the physical value supply circuit and the control terminals for the threshold values of the logical devices are connected by using wiring patterns contained in a wiring layer formed by masks individually designed by the user. With this arrangement, the operation modes of the individual logical devices can be suitably set according to the operating states of the logical devices. Accordingly, the operation modes, including the operating speed and the power consumption of the individual logical devices forming the master slice integrated circuit, can be more suitably determined. It is thus possible to provide a logical unit achieving both high speed and low power consumption.

As means for electrically controlling the threshold values of the logical devices, for example, the body bias voltages of MOS field effect transistors may be changed, or double-gate field effect transistors may be used, in which case, the threshold voltage when a signal is input into one gate terminal is controlled by the control voltage added to the other gate terminal. In these methods, a fourth terminal for controlling the threshold voltage of the transistor is prepared, and a wiring pattern in the wiring layer is connected to the fourth terminal as well as the other three terminals. Then, a voltage supply circuit for generating a plurality of different control voltages is integrated into the master slice integrated circuit. The output terminal for supplying one of the control voltages generated in the voltage supply circuit is connected with the fourth terminal for controlling the threshold voltage of the transistor by using a wiring pattern formed by a mask designed by the user. Thus, the operation modes of the individual logical devices can be suitably set according to the operating states of the corresponding logical devices.

The control physical values (control voltages) for controlling individual logical devices are determined according to the operations of the corresponding logical devices forming a logical unit and by determining the threshold values suitable for increasing the operating speed and decreasing power consumption.

When a logical unit implementing predetermined functions is formed by combining logical gates of logical devices such as transistors, some logical devices become a bottleneck in the overall logical unit, and thus, signals must pass through these logical devices quickly (logical devices through which a critical path signal passes), but other logical devices do not present such a problem. Then, design data (net list) for a logical unit formed by an integrated circuit is analyzed, and then, signal lines to form a critical path are specified. This makes it possible to distinguish logical devices that must be operated at high speed from the other logical devices. Then, the operating speeds required for the individual logical devices are determined.

In the present application, the “critical path” is defined as a path in a circuit, through which, among internal signals which are necessary to certainly output an output signal(s), a signal(s), which is transmitted (most) slowly, passes through, wherein an operation speed of the circuit is determined thereby.

Then, to form a master slice integrated circuit including many logical devices (such as transistors), masks for wiring patterns are formed so that a physical value (voltage) for controlling the operation mode to increase the operating speed is supplied to the control terminals for the threshold values of the logical devices that must be operated at high speed and so that a physical value (voltage) for reducing the power consumption as much as possible without reducing the overall speed is supplied to the control terminals for the threshold values of the logical devices that do not have to be operated at high speed.

In the resulting master slice integrated circuit, the operating speed becomes higher while consuming low power according to the operation of each logical device forming a logical unit. It is thus possible to provide a high-speed and low-power logical unit.

Accordingly, the present invention provides a high-speed and low-power logical unit includes a plurality of logical devices such as transistors (formed by a common masks) including control-physical value input terminals (control-voltage input terminals in case of a transistor) for controlling operation modes, a physical value supply circuit (a voltage supply circuit in case of a transistor) formed by the common mask for generating a plurality of different control physical values (control voltages), and a wiring pattern (formed by masks individually designed) for supplying a control physical value from the physical value supply circuit (voltage supply circuit in case of a transistor) for controlling each of the logical devices to operate in an operation mode determined according to an operation of the corresponding logical device to the control-physical value input terminal of the corresponding logical device.

The operation mode of each logical device may be one of a first operation mode in which the operating speed is higher and power consumption is higher, a second operation mode in which the operating speed is lower and power consumption is lower, and a third operation mode in which the operating speed is intermediate and power consumption is intermediate. The operation mode may change a threshold value (voltage) of a logical device according to the control physical value (voltage) for controlling the operation mode, and switches between the first operation mode, the second operation mode, and the third operation mode.

In the high-speed and low-power logical unit, the physical value supply circuit may be a voltage source for generating a plurality of different control voltages for changing the threshold voltages of the field effect transistors, and the operation modes of the transistors may be switched to change the threshold voltages by the control voltages supplied from the voltage source. The control-physical value input terminal may be provided for each of the logical devices or for a plurality of logical devices which are operated in association with each other.

As described above, according to the present invention, the operating speed and power consumption of individual logical devices (such as transistors) forming a logical unit can be suitably controlled by physical values (control voltages in case of transistor) for controlling the operation modes of the logical devices. Accordingly, by using a master slice integrated circuit formed of a plurality of logical devices including an extra control-physical value input terminal for controlling the operation mode, a wiring pattern is disposed so that the suitably determined control physical value (control voltage) is input into the extra control-physical control input terminal. It is thus possible to provide a logical unit that operates at high speed while consuming low power.

That is, to form a logical unit by using a master slice integrated circuit, masks for a wiring layer for wiring patterns are formed so that a control physical value (voltage or current) for controlling the operation mode to increase the operating speed is supplied to the control-physical value input terminals for the operation mode of the logical devices that must be operated at high speed and that a physical value for reducing the power consumption as much as possible without reducing the overall speed is supplied to the control-physical value input terminals for the operation mode of the logical devices that do not have to be operated at high speed. With this configuration, it is possible to form a logical unit that operates at high speed while consuming low power.

The present invention will become more apparent from the following detailed description of the embodiments and examples of the present invention

### DESCRIPTION OF THE DRAWINGS

The present inventions will now be described by way of example with reference to the following Figures, in which:

FIG. 1 illustrates the configuration of a master slice integrated circuit chip for a high-speed and low-power logical unit according to an embodiment of the present invention;

FIG. 2 illustrates the structure of four logical devices (transistors) disposed in a logical device (transistor) region and formed by a common mask;

FIG. 3 illustrates an example of a two-input NAND gate formed by connecting the terminals of four logical devices (transistors) by using a wiring layer so as to control the operation modes by voltages applied to control voltage terminals Cn and Cp;

FIG. 4 illustrates a control-voltage supply circuit for controlling the operation modes and part of a circuit around the voltage supply circuit;

FIG. 5 is a flowchart illustrating a process for determining operation-mode control voltages; and

FIG. 6 illustrates an example of a critical path in a circuit configuration of a logical unit and an example of logical device (transistors) whose operation modes are suitably set based on the critical path.

### DETAILED DESCRIPTION OF THE INVENTION

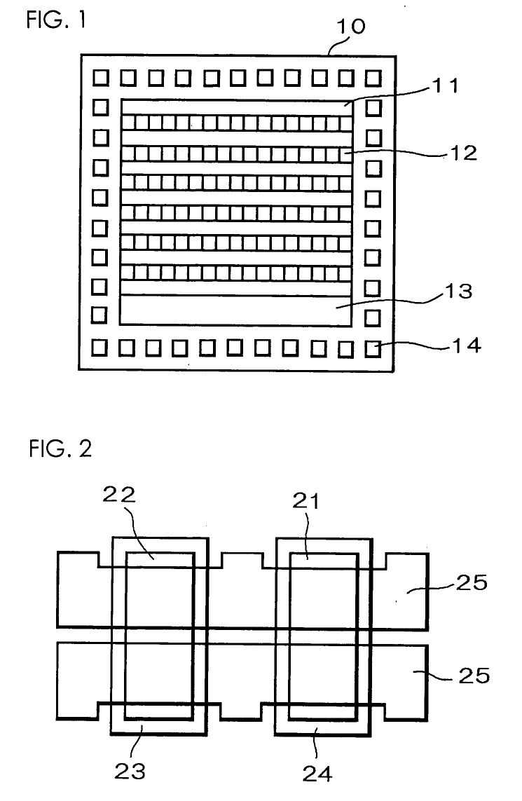

An embodiment of the present invention is described below with reference to the drawings. FIG. 1 illustrates the configuration of a master slice integrated circuit chip 10 forming a high-speed and low-power logical unit according to an embodiment of the present invention.

In the present invention, the logical device is defined as “a device in which a switching device is operated by input physical value. Whether output physical value becomes an ON state or Off state is determined by the relationship between the input physical value and a threshold value of the device which is set beforehand. In addition, the setting of the threshold level affects the output physical value in ON and OFF states, and the output physical value in the ON state affects the switching operation speed. The output physical value in the OFF state affects energy loss. Thus, there is a trade-off relationship between the switching operation speed and the energy loss whereby the operating mode of the logical device depends on the setting of the threshold value.

In the following embodiments according to the present invention, description of a transistor(s) as an example of logical devices, will be given. Thus, the logical devices are not limited to the transistors.

In FIG. 1, the logical unit includes the high-speed and low-power logical unit chip 10 formed by a master slice integrated circuit, a wiring channel region 11, a transistor region 12, a control-voltage supply circuit 13, and bonding pads 14.

In the transistor region 12, many transistors formed by a common mask(s) are disposed. The transistors comprise, for example, MOSFETs. The terminals of these transistors are connected by using the wiring channel region 11 in a wiring layer formed by individually designed new masks, thereby forming basic logical gates, such as flip-flops, inverters, AND gates, and OR gates. Wiring patterns are also disposed to connect the logical gates and to connect the logical gates and the bonding pads 14 for inputting and outputting external signals. Then, the logical unit can be fabricated in the wiring layer.

To dispose the wiring patterns, the wiring channel region 11 is utilized. In the chip 10 forming the logical unit, as a voltage supply circuit for generating a plurality of different control voltages, the control-voltage supply circuit is provided (by a common mask), and the control voltages are output from the control-voltage supply circuit 13 so as to control the operation modes of the individual transistors in the transistor region 12. By using the wiring layer formed by the wiring mask, the control input terminals of the individual transistors are connected to the corresponding output terminals of the control-voltage supply circuit 13 for outputting the control voltages associated with the operation modes of the transistors. Then, all the transistors are operated in the optimal operation modes.

FIG. 2 illustrates the structure of four transistors disposed in the transistor region 12 formed by the common mask(s). Two P-channel MOS transistors are formed at the intersections between a P-channel region 22 and two polysilicon gates 25. Two N-channel MOS transistors are formed at the intersections between an N-channel region 21 and the two polysilicon gates 25. The terminals of these MOS transistors are connected by the wiring layer formed by the mask(s) so as to form basic logical gates, such as NAND gates, NOR gates, and inverters.

An N-well region 23 is formed under the P-channel region 22, while a P-well region 24 is formed under the N-channel region 21. Accordingly, by changing the potentials (body bias) of the wells, the threshold voltages of the MOS transistors can be changed so as to control the operation modes of the MOS transistors.

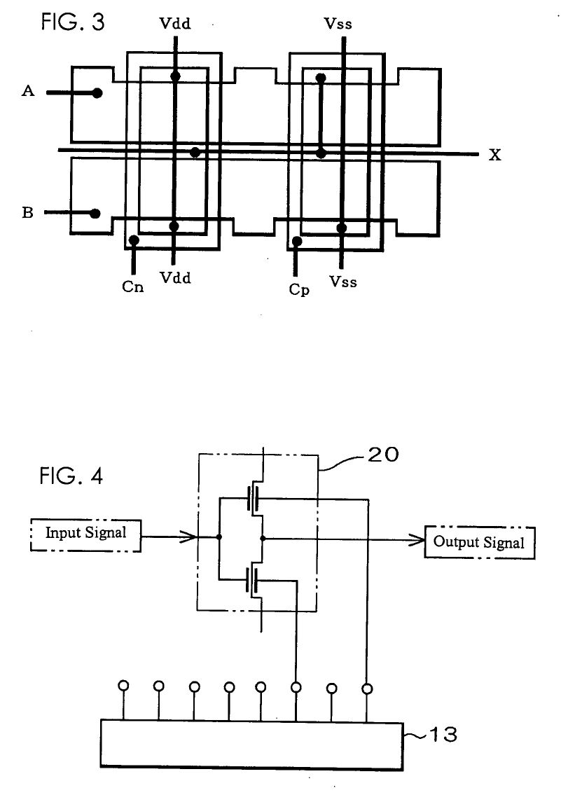

FIG. 3 illustrates an example of a two-input NAND gate formed by connecting the terminals of four transistors by using the wiring layer so as to control the operation modes by the voltages applied to control voltage terminals Cn and Cp. This logical circuit is formed of a master slice integrated circuit. Accordingly, the four transistors shown in FIG. 3 have the same structure as that shown in FIG. 2, i.e., the four transistors are formed by a common mask, and the wiring patterns formed by the wiring layer are formed by individually designed masks. With this arrangement of the wiring patterns, the operation modes of the individual transistors can be controlled by the voltages applied to the control voltage terminals Cn and Cp, as discussed below.

Power supply voltages Vdd are input into a wiring pattern connected to the drain terminals of the two P-channel MOS transistors. An input signal A is input into the upper polysilicon gate, while an input signal B is input into the lower polysilicon gate. An output signal X is input into the source terminals of the two P-channel MOS transistors and the drain terminal of the upper N-channel MOS transistor, and is output to the outside of the NAND gate. The control voltages supplied from the control-voltage supply circuit 13 to the wiring pattern connected to the control voltage terminal Cn connected to the N-well region and to the control voltage terminal Cp connected to the P-well region are control signals determining the operation modes of the transistors. The wiring patterns from the control-voltage supply circuit 13 are disposed so that control voltages for controlling the operation modes of the transistors are supplied. More specifically, the control-voltage supply circuit 13 is provided with output terminals for outputting a plurality of different control voltages that allow the transistors to be operated in the optimal operation modes. The transistors are connected to the corresponding output terminals of the control-voltage supply circuit 13 which output the potentials suitable for the transistors.

FIG. 4 illustrates the control-voltage supply circuit 13 and an example of a circuit around the control-voltage supply circuit 13. As an example of a transistor, the circuit configuration using a double-gate field effect transistor is shown. A logical gate, such as a logical gate circuit 20 shown in FIG. 4, formed by a transistor, is configured so that the threshold voltage of the logical gate circuit 20 is controlled by the control voltage supplied from the control-voltage supply circuit 13.

The control voltages supplied from the control-voltage supply circuit 13 are determined, as described below, according to the configuration of the logical circuit when circuit setting data and circuit configuration data are designed. The control voltages determine the operation modes of the individual transistors so that the operating speed and the power consumption of the transistors forming the logical gates can be controlled.

Although a double-gate field effect transistor is shown in FIG. 4, another type of circuit, for example, the above-described circuit in which the substrate potential of a MOS transistor is changed to control the threshold of the transistor, may be used. In this case, the control voltage supplied from the control-voltage supply circuit 13 changes the voltage applied to the substrate (well region). Accordingly, the threshold voltage of the MOS transistor is changed so that the current driving power and the leakage current of the transistor can be controlled. As a result, the operating speed and the power consumption of the transistor can be controlled.

As in this embodiment, a mask(s) of a wiring layer is designed by using a master slice integrated circuit formed by a plurality of transistors in a transistor region. In this case, after analyzing the circuit of a logical unit to be formed, the control voltages for controlling the operation modes that can maximize the operating speed and minimize the power consumption according to the configuration of the circuit can be determined, for example, in the following manner.

To fabricate masks for the wiring layer of the master slice integrated circuit, a placement-and-routing program for master slice integrated circuits is used. By inputting design data (net list) consisting of information concerning connection between the logical gates in a logical circuit into the placement-and-wiring program for the master slice integrated circuit, the placement (which signal lines of the transistors are to be used for implementing the individual logical functions of the logical circuit) and the routing (which transistors are to be connected) of the logical gates can be determined. The placement-and-routing program outputs design data indicating the determined placement and routing.

The placement-and-routing program determines the relationship (mapping) between all the logical gates and the transistors in the integrated circuit so that the fastest circuit operation can be achieved by considering a delay in the logical gates and in the wiring patterns, and then computes placement-and-routing data that determines the wiring state between the transistors. When completing the calculations of the placement-and-routing data that maximizes the speed of the circuit operation, the placement-and-routing program holds information concerning the delay time in all the logical gates and in the wiring patterns in the circuit as internal information. In this case, a critical path in the circuit is also specified.

Then, after completing the placement-and-routing operation, for the transistors containing the gates in the critical path, the control voltage that can maximize the operating speed of such transistors is determined. Then, for the transistors containing the gates that are not disposed in the critical path, the control voltage for such transistors is changed to decrease the operating speed, and while changing the control voltage, it is checked whether the critical path is changed. As the operating speed for the gates that are not disposed in the critical path decreases, such gates eventually become contained in the critical path. Accordingly, the control voltage that allows the transistors containing such gates to operate in the operation mode at one level before the level of the speed that cause the transistors to be contained in the critical path is set. The above-described operation is repeatedly performed on all the gates.

According to the above-described process, the control voltages for controlling the operation modes of the individual transistors that maximize the operating speed of the overall logical unit and minimize the power consumption can be determined. If the sum of the power consumption of all the transistors is restricted, the operating speed of some transistors is further reduced. Then, finally, information concerning the wiring patterns disposed from the voltage supply circuit for generating a plurality of different voltages, i.e., from the output terminals of the voltage supply circuit for outputting voltages required for controlling the operation modes of the individual transistors to the control-voltage input terminals of the transistors is added to the placement-and-routing data. Based on this data, masks for the wiring layer in the master slice integrated circuit are fabricated.

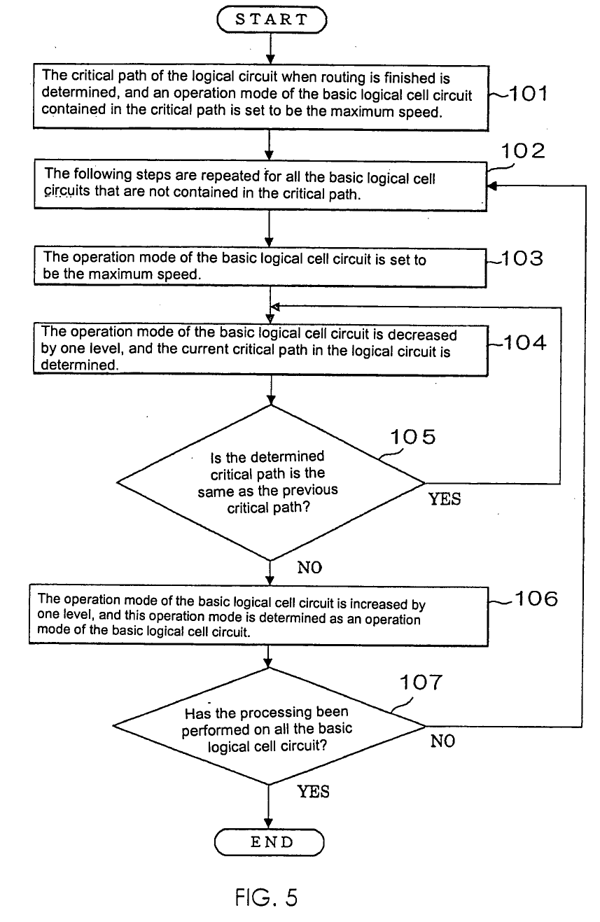

FIG. 5 is a flowchart illustrating a process for determining operation-mode control voltages for controlling the operation modes. Details of the process are discussed below with reference to FIG. 5. In this process, placement-and-routing data for a logical unit is input, and processing for determining a critical path in the logical unit based on a placement-and-routing program is performed as a subroutine. When the process starts, in step 101, the critical path of the logical circuit (logical unit) when the routing is finished is determined, and the operation mode of the transistors contained in the critical path is set to be the maximum speed. Then, the process proceeds to step 102. Step 102 carries out control, together with step 107, so that steps 103 through 107 are sequentially repeated for all the transistors that are not contained in the critical path.

As the initial setting, the operation mode of a transistor (logical gate) is set to be the maximum speed (step 103). Then, the operation mode of the transistor is decreased by one level, and the current critical path in the logical circuit (logical unit) is determined (step 104). It is then determined whether the determined critical path is the same as the previous critical path (step 105). If so, there is no change in the critical path in the logical circuit (logical unit), and it can be determined that the operating speed of the transistor can be decreased to reduce the power consumption without decreasing the speed of the overall logical circuit (logical unit). The process then returns to step 104 to determine whether the operating speed of the transistor can further be decreased to reduce the power consumption.

If it is determined in step 105 that the determined critical path is not the same as the previous critical path, it means that the critical path in the logical circuit (logical unit) is changed. Accordingly, if the operating speed of the transistor is decreased to reduce the power consumption, the overall speed of the logical circuit (logical unit) is unfavorably decreased. In this case, to cancel the operation performed in step 104, in step 106, the operation mode of the transistor is increased by one level, and this operation mode is set for the transistor. It is then determined whether the processing has been performed on all the transistors (step 107). If not, the process returns to step 102, and step 103 and the subsequent steps are repeated for the subsequent transistor. If the processing has been performed on all the transistors, the control voltages for controlling the operation modes of all the transistors have been determined. The process is then completed.

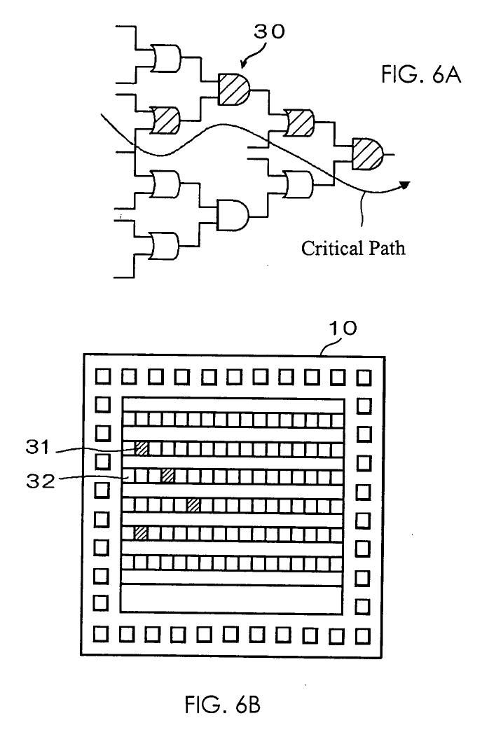

FIG. 6 illustrates an example of a critical path in a circuit configuration of a required logical unit and an example of transistors whose operation modes are suitably set according to the critical path. In FIG. 6A, logical gates disposed in the critical path are indicated by hatched portions. In FIG. 6B, transistors containing such logical gates in which the control voltage allowing the highest operating speed is set are also indicated by hatched portions. As shown in FIG. 6(b), when a logical unit 30 is formed by a plurality of transistors, the control voltage allowing the highest operating speed is set for transistors 31 forming the logical gates disposed in the critical path, and the control voltage allowing the lower-speed operation mode by one level or the control voltage allowing the lowest operation mode is set for transistors 32 forming the other logical gates.

According to the foregoing description, in a logical unit using a master slice integrated circuit, a control voltage for increasing the operating speed can be applied to the control-voltage input terminals of transistors forming logical gates that must be operated at high speed, and a control voltage that can decrease the power consumption can be applied to the control-voltage input terminals of the transistors forming the other logical gates. It is thus possible to provide a logical unit that achieves fast operation while consuming low power.

Also, although voltages are used as the physical control values, other physical value such as current may be used to control the logical devices.

In the above description, as the embodiments, the present invention is applied to a master slice integrated circuit. However, the present invention is not limited to it. That is in the above description of the present invention, as the embodiments of the present invention, the logical unit in which transistors of a transistor layer is wired in a wiring layer, is described. However, the present invention is not limited to it and may be applied to a logical unit in which a more functional logical element configured by wiring transistors of a transistor layer in a lower wiring layer is wired in an upper wiring layer. (The logical element is more functional than a sole transistor.) Thus, the present invention may be applied to gate-array devices, structured ASIC, fully customized integrated circuits, cell-based integrated circuits and the like. Various logical units in the range from basic gates to hardware macro (devices) may be used in terms of the complexity and size of a logical circuit which is prepared beforehand.

Thus the present invention possesses a number of advantages or purposes, and there is no requirement that every claim directed to that invention be limited to encompass all of them.

The disclosure of Japanese Patent Application No. 2003-341191 filed on Sep. 30, 2003 including specification, drawings and claims is incorporated herein by reference in its entirety.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A high-speed and low-power logical unit comprising:
a plurality of logical devices having corresponding control-physical value input terminals for controlling operation modes;
a physical value supply circuit for generating a plurality of different control physical values; and
a wiring pattern for supplying control physical value from the physical value supply circuit for controlling each of the logical devices to operate in one of operation modes which is determined according to an operation of the corresponding logical device, to the control-physical value input terminal of the corresponding logical device.

2. The high-speed and low-power logical unit according to claim 1, wherein the operation modes comprise at least a first operation mode in which operating speed is higher and power consumption is higher and a second operation mode in which the operating speed is lower and power consumption is lower.

3. The high-speed and low-power logical unit according to claim 1, wherein the operation modes comprises at least a first operation mode in which operating speed is higher and power consumption is higher, a second operation mode in which the operating speed is lower and power consumption is lower, and a third operation mode in which the operating speed is intermediate and power consumption is intermediate.

4. The high-speed and low-power logical unit according to claim 2, wherein the one of operation modes changes threshold physical value of the logical devices according to the control physical value for controlling the operation mode, and switches between the first operation mode and the second operation mode.

5. The high-speed and low-power logical unit according to claim 3, wherein the one of operation modes changes threshold voltage of the logical devices according to the control physical value for controlling the operation mode, and switches between the first operation mode, the second operation mode, and the third operation mode.

6. The high-speed and low-power logical unit according to claim 2, wherein each of the logical devices comprises a transistor and the control physical value comprises control voltage, and the one of operation modes changes threshold voltage of the logical devices according to the control voltage for controlling the operation mode, and switches between the first operation mode and the second operation mode.

7. The high-speed and low-power logical unit according to claim 3, wherein each of the logical devices comprises a transistor and the control physical value comprises control voltage, and the one of operation modes changes threshold voltage of the logical devices according to the control voltage for controlling the operation mode, and switches between the first operation mode, the second operation mode, and the third operation mode.

8. The high-speed and low-power logical unit according to claim 6 or 7, wherein the voltage supply circuit is a voltage source for generating a plurality of different control voltages for changing the threshold voltages of the transistors, and the operation modes of the transistors are switched by the wiring pattern disposed from the voltage source to the control-voltage input terminal.

9. The high-speed and low-power logical unit according to claim 1, wherein the control-physical value input terminal is provided for each of the logical devices or for a plurality of logical devices which are operated in association with each other.
